(19) United States
(12) Patent Application Publication
(10) Pub. No.: US 2005/0200916 A1
(43) Pub. Date: Sep. 15, 2005

(54) Scanner

(76) Inventors: Ta-Yi Lee, Taipei (TW); Jung-Chiao Chang, Taipei (TW)

Correspondence Address: BIRCH STEWART KOLASCH & BIRCH, PO BOX 747, FALLS CHURCH, VA, 22040-0747, US

(21) Appl. No.: 10/798,392

(22) Filed: Mar. 12, 2004

(51) Int. Cl. H04N 1/04

(52) U.S. Cl. 358/474

(57) ABSTRACT

A scanner which replaces CCFL with LED as a light source so as to solve the problem of excessively long warm-up time of CCFL in the prior art is provided. Meanwhile, objects as rod lens, reflectors, brightness enhancement films (BEF), or diffusers may be applied to enhance and even the brightness of the LED.

### FIELD OF THE INVENTION

The present invention relates to a scanner and particularly to a scanner that uses LED as the light source.

### BACKGROUND OF THE INVENTION

The scanner, aside from the keyboard and mouse, is a widely used computer input device. It can be used to input photos to generate personal electronic picture files, or input pictures to set up a personal Web site. Or hand-written letters may be sent by scanning and E-mail to replace FAX machines. The scanner can also be coupled with OCR software to enter contents of newspapers or books without the tedious labor of manual data entry. All this shows the powerful functions of the scanner. It greatly improves the efficiency in offices, learning and recreation.

The scanner achieves its functions mainly by digitizing the picture. Light is emitted from a lamp and reflected to a document held on a glass plate of the scanner. The bright and dark differences of the document form reflection light of different intensity. The reflection light passes through a series of reflection mirrors and focuses on a CCD at another end of the lens. The CCD transforms optical signals to correspond electric signals, namely analog signals. These signals are transformed by an A/D converter to become digital signals recognizable by computers. Through various interfaces such as an EPP (Enhanced Parallel Port), USB (Universal Serial Bus), or a SCSI (Small Computer System Interface), the digital signals are sent to a computer.

The A/D converter is a semiconductor element for transforming the analog signals to digital signals. The electric signals obtained by a CCD are simulated signals corresponding to the brightness and darkness of the image. Namely, variations from the darkness to brightness of the image can be indicated by different electric potentials. They change continuously, and are called simulated amount.

In the scanner, the light source is important. The light sensed by a CCD is emitted from the lamp of the scanner. Impure or polarized light directly affects the scanning result. The professional scanners or some high-end home or office scanners automatically test the light intensity emitted from the lamp before scanning, especially when the scanner has just been powered on. As the lamp is not yet stable, and the scanner has a specific warm up period, only when the light intensity reaches the required standard the light testing sensor in the scanner issues an approval instruction. Then the scanner can reach the optimal condition to process scan operation. Otherwise the light intensity cannot effectively present the details of the dark portions of the document.

Conventional scanners generally use a cold cathode fluorescent lamp (CCFL) as the light source. Such a lamp has a big drawback, it requires a warm up time when the scanner is powered on each time to enable the brightness of the lamp to increase to a stable condition. The warm up time could last about 1-3 minutes. It is an idling time many users feel is unbearable. Some users even mistakenly deem it as machine malfunction and request product return. This is especially significant and serious in a low temperature environment.

In view of the foregoing problems, balancing the quality and providing fast and efficient scanning and preview, and reducing waiting time when the scanner is cold started have become a highly pursued goal in the industry.

### SUMMARY OF THE INVENTION

The primary object of the invention is to provide a scanner that uses an LED as the light source to resolve the problem of a long warm up time occurred to the conventional scanners.

In order to achieve the foregoing object, the scanner according to the invention uses a LED lamp set to emit light to pass through a transparent plate and project onto a scanning object. The bright and dark differences of the scanning object form reflection light of different intensity to pass through the transparent plate and to be reflected by a reflection mirror set, then to be focused on an image sensor for sensing.

The image sensor is a charge-coupled device (CCD).

Abutting the LED lamp set, there is at least one rod lens. Light emitted from the LED lamp set is refracted by the rod lens to become light with more even brightness.

Aside from the rod lens, to increase the brightness and evenness of the light of the LED lamp set, at least one reflection surface is disposed at a suitable location around the LED lamp set, to gather the scattered light and focus the light to, achieve sufficient and even brightness.

Moreover, at least one brightness enhancement film (BEF) or diffuser is disposed at a suitable location around the LED lamp set to increase even distribution and brightness of the light emitted from the LED lamp set.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 is a schematic view of a first embodiment of the invention.

FIG. 2 is a schematic view of a second embodiment of the invention.

FIG. 3 is a schematic view of a third embodiment of the invention.

### DESCRIPTION OF THE PREFERRED EMBODIMENTS

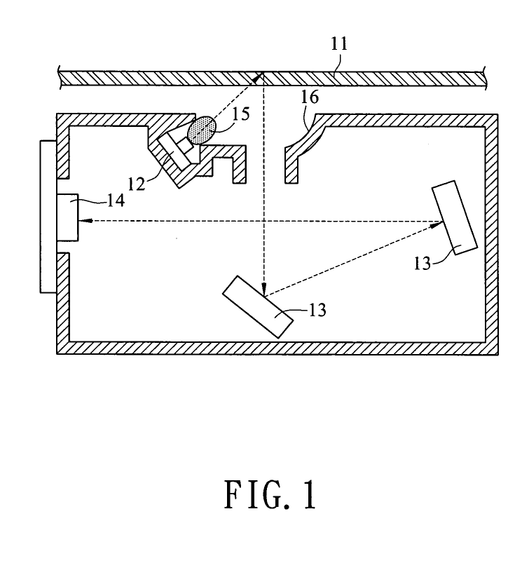

Refer to FIG. 1 for a first embodiment of the scanner of the invention.

The scanner includes a transparent plate 11, an LED lamp set 12, a reflection mirror set 13 and an image sensor 14.

The LED lamp set 12 consists of at least one LED lamp to serve as the light source to emit light.

The transparent plate 11 has one side corresponding to the LED lamp set 12 and another side corresponding to a scanning object (not shown in the drawing). Light emitted from the LED lamp set 12 passes through the transparent plate 11 and projects onto the scanning object.

The reflection mirror set 13 consists of at least one reflection mirror to reflect and focus the light reflected from the scanning object after having been projected by the light emitted from the LED lamp set 12.

The image sensor 14 is a charge-coupled device (CCD) to receive light reflected from the reflection mirror set 13, and transforms the optical signals to analog signals to output.

A CCD is a photoelectric device fabricated through microelectronic technology to perform photoelectric transformation. It is widely used in video cameras, digital cameras and scanners. In the video cameras, matrix CCDs are used to capture plane images in X and Y directions. The scanner uses a linear CCD in X direction. Scanning in Y direction is accomplished through a mechanical apparatus of the scanner. A CCD chip has many photosensitive elements to convert different lights to different electric charges, to form a charged picture corresponding to the photo picture of the original scanning document. The number of photosensitive elements of the CCD should be increased if increasing picture resolution is desired. In fact, the CCD performance determines the optical resolution of the scanner in the X direction.

The LED lamp set used in the scanner of the invention replaces the conventional CCFL. An LED (light emitting diode) is an electronic element which emits light when energized by electricity. It is a light emitting element fabricated from semiconductor material that includes III-V family chemical elements (such as a GaP, GaAs, and the like). It transforms electric energy to light. Namely, when an electric current is applied on the semiconductor compound, through coupling of electrons and electric holes, extra energy is released in the form of light to generate a light emitting effect. It is a cold light, and has a service life of one hundred thousand hours or more.

As the LED does not have idling time, and can respond quickly, it can overcome the disadvantage of lengthy idling time occurring to CCFL, therefore can improve preview and scanning speed, and reduce cold start waiting time.

However, an LED usually is a point light source and does not have adequate brightness. The scanner usually uses a linear or plane light source for scanning operation, hence the invention provides at least one rod lens 15 close to the LED lamp set 12, to refract the light emitted from the LED lamp set 12, to achieve even brightness.

Thus the operation principle of the invention is to place the scanning object (not shown in the drawings) on one side of the transparent plate 11; the LED lamp set 12 located on another side of the transparent plate 11 emits light; the emitted light is refracted by the rod lens 15 and focused to pass through the transparent plate 11 and project onto the scanning object. According to dark and bright differences of the scanning object, reflection light of different intensity is formed to pass through the transparent plate 11, and is reflected by the reflection mirror set 13, to focus on the image sensor 14 for sensing.

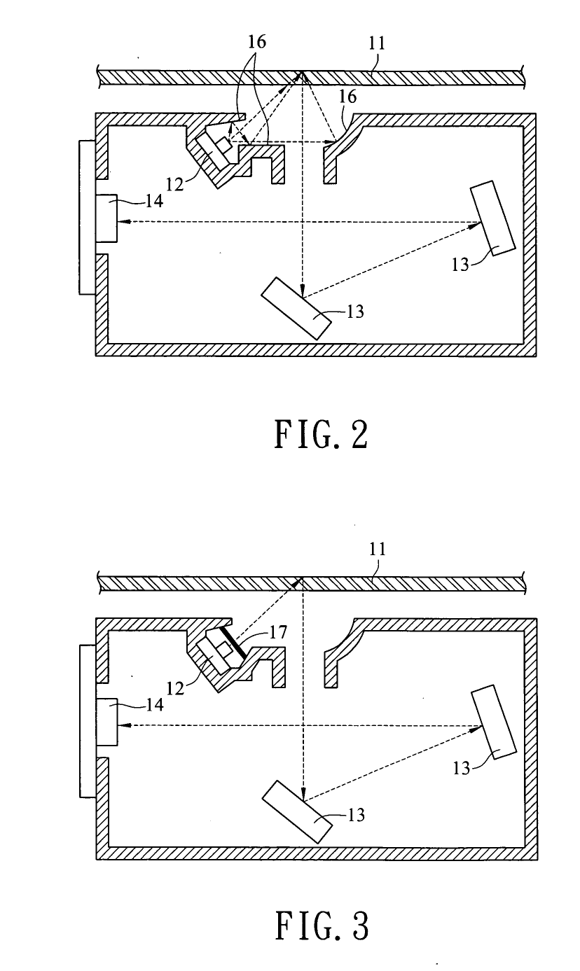

Refer to FIG. 2 for a second embodiment of the invention. Aside from the rod lens 15, to increase and even the brightness of the light emitted from the LED lamp set 12, at least one reflection surface 16 is disposed at a desired location around the LED lamp set 12 to reflect and gather the scattered light and achieve even brightness.

Refer to FIG. 3 for a third embodiment of the invention. At least one BEF (Brightness Enhancement Film) 17 or diffuser is disposed at a desired location around the LED lamp set 12, to enable the light emitted from the LED lamp set to become more uniform and have greater brightness.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

1. A scanner, comprising:
a LED lamp set which includes at least one LED lamp to serve as a light source;
a transparent plate having one side corresponding to the LED lamp set and other side corresponding to an object to be scanned, light emitted from the LED lamp set passing through the transparent plate to project onto the scanning object;
a reflection mirror set which includes at least one reflection mirror for receiving a light reflecting from the object to be scanned, where the light is emitted from the LED lamp set, and which reflects and focuses the light; and
an image sensor for receiving the light reflected from the reflection mirror set and transforming received optical signals to analog signals for outputting.

2. The scanner of claim 1, wherein the image sensor comprises a charge-coupled device.

3. The scanner of claim 1 further having at least one rod lens close to the LED lamp set at a desired location to refract and focus the light emitted from the LED lamp set.

4. The scanner of claim 1 further having at least one reflection surface close to the LED lamp set at a desired location to reflect and focus the light scattered from the LED lamp set.

5. The scanner of claim 1 further having at least one BEF (brightness enhancement film) close to the LED lamp set at a desired location to focus the light emitted from the LED lamp set.

6. The scanner of claim 1 further having at least one diffuser close to the LED lamp set at a desired location to focus the light emitted from the LED lamp set.
